(19) United States
(12) Patent Application Publication
(10) Pub. No.: US 2025/0289101 A1
(43) Pub. Date: Sep. 18, 2025

(54) Screw Holder

(71) Applicant: Epic Ventures Inc., Sidney (CA)

(72) Inventor: Sebastien Nathaniel Berrang, Ilkley (GB)

(73) Assignee: Epic Ventures Inc., Sidney, BC (CA)

(21) Appl. No.: 18/980,287

(22) Filed: Dec. 13, 2024

Related U.S. Application Data
(60) Provisional application No. 63/564,834, filed on Mar. 13, 2024.

(51) Int. Cl. B25B 23/10

(52) U.S. Cl. CPC B25B 23/101

(57) ABSTRACT

A screw holder for holding a screw to be driven by a screwdriver. The screw holder may include a longitudinal holder body with first and second ends. A through-hole may be provided from the first to the second end, with the first end having an opening configured to receive a blade and shank of a screwdriver, and the second end having an opening configured to receive the screw. The second end opening may progressively taper towards the first end. The through-hole may be configured to allow the blade of the screwdriver the engage with the head of the screw within the holder body.

### FIELD OF THE INVENTION

There is described a universal screw holder construct adapted to allow the user to securely hold most screw sizes to the tip of most screwdriver diameters, thereby allowing the user to insert, by turning the screwdriver, the screw into a substrate material, using only one or two hands to hold the screwdriver, without needing to hold the screw.

BACKGROUND

Screws are widely used as a secure, simple and reliable means to fasten wood, metal, and other materials securely together.

Accordingly, there exists a wide array of screw designs, and screw heads, with such heads able to accommodate screwdriver tips having, for example, Slotted, Phillips, Square, Hex and Star configurations.

In some cases the screw is only loosely held by the tip of the screwdriver, especially if the screw and/or screwdriver tip are worn, thereby allowing the screw to bend or tilt and fall off, requiring the user to use two hands, one to hold the screw and the other to hold the screwdriver.

Thus, in instances where the physical confines or distance restrict the use of two hands or when it is difficult to secure the screw to the tip of the screwdriver, for instance, in slippery conditions, it is useful and convenient to have the screw securely held to the tip of a screwdriver while inserting the screw with one hand or both hands.

To address the issue of the screw falling off the screwdriver tip, there exists various prior art. For example, there exists a “Screw Gripper” branded as Wera™ by Bitburger™ Holding GmbH of Wuppertal, Germany.

An identical version of the Wera™ Screw Gripper is also manufactured by Tao Hua Yuan™ (Hunan, China).

In another embodiment, the prior art discloses the use of a piece of plastic (or rubber) tubing to hold the screwdriver head to the screw, with a partial slit in such tube to allow for the larger diameter of the screw head, although such device does not appear to be commercially available. Testing of this design proved to not be practical, as the screw easily tilts and dislodges from the tubing, or tends to bend to one side during the effort to insert the screw.

Additionally, the prior art describes simply using putty adhesive, or tape to hold the screw head to the screwdriver tip. However, such approaches are not practical or suitable for multiple or large scale requirements in many applications requiring screw insertions. The prior art also discloses the use of magnetized screwdriver tips to hold screws in place during screw insertion. The inclusion of magnetic materials, such as ceramic or rare earth-based magnetic alloys increases cost, and does not work for non-ferromagnetic materials, such as most stainless steels, brass or plastic screws. Also, the magnetized tip of the screwdriver can only accommodate one size screw head, which aspect requires the user to match the screwdriver tip with the screw head.

In yet another prior art embodiment, a screwdriver tip is modified to hold a Phillips screw head, which design appears limited to one size Phillips screw head for each screwdriver size.

Of note, all prior art designs only hold a screw at one location, that is, at the head of the screw. Such “one point” grip by the screwdriver tip to the head of the screw enables the screw to easily bend over, or tilt, preventing insertion of the screw by a user only using one or two hands to turn the screwdriver handle.

The limitations of the above-mentioned prior art designs are further addressed in the Detailed Description of the Drawings section.

Accordingly, a need exists to overcome the limitations of the prior art. Other objects of the invention will be apparent from the description that follows.

### SUMMARY

The inventive screw holder construct enables the user to firmly hold a screw on the screwdriver tip while inserting the screw into a substrate using only one or two hands holding the screwdriver handle, without the screw dislodging and falling off the tip of the screwdriver.

Critically, the preferred embodiment screw holder is adapted to accommodate various diameters of screwdriver shafts and also to hold a wide array of screw types, such as screws having Slotted, Phillips, Square, Hex and Star configurations and the like.

Such screw holder design to fit various screwdriver shaft diameters and screw types is made possible by the screw holder having a spiral slot along the length of the screw holder. Such spiral slot allows for the expansion of the inner diameter of the screw holder while maintaining a substantially round shape so as to snugly fit to the round diameter of the screwdriver shaft, thereby allowing for the use of a wide array of screwdriver diameters, for example, diameters ranging from 5 mm to 10 mm, to be snugly held by the screw holder.

The inclusion of a spiral slit along the length of the screw holder also allows for the screw holder to snugly hold most sizes of screw heads.

Additionally, the cone shaped configuration section of the screw holder has an inner surface with a roughened, textured, dimpled, protruding-rings or such, which surface feature creates a non-smooth surface. Such non-smooth inner surface of the inner cone induces increased friction and screw alignment to hold most sizes or screw heads and thus prevent the screw from falling off the screwdriver tip.

The screw's linear alignment with the screwdriver shaft during insertion is also assisted at a second position by an elastomeric or polymeric membrane covering over the large opening end of the funnel, which elastomeric or polymeric covering has three or more slits to allow for entry of the screw head and screw body, into the funnel, which design acts to hold the screw shaft or body from bending or tilting out of linear alignment with the screwdriver shaft.

In an alternate embodiment, the spiral slot is straight, rather than spiral. Such a design, although technically functional, is not optimal, as the diameter of the screw holder is non-round when the slot opening is increased to accommodate a larger round diameter of a screwdriver shaft.

The inventive screw holder can be produced using well known prior art methods such as mold injection, casting, or 3-D printing, which processes can provide for very low cost of production, this is, less than $0.10 USD per unit in volume production.

The screw holder can also be made of a lightweight foamed polymer material, for example, EVA (ethylene vinyl acetate), polyethylene or such, including foamed elastomeric materials, which materials are well known in the prior art.

Additionally, depending on the material used to fabricate said screw holder, such holder may also be recyclable, especially when the screw holder material is comprised from a single thermoplastic polymer group.

Notably, the inventive screw holder material is preferably comprised of a polymer material such as polyethylene, polypropylene, polyamide (nylon), ethylene vinyl acetate, or such, or an elastomeric material such as natural rubber, SBR, butyl or silicone, with a durometer in the range of Shore A30-60.

In accordance with another embodiment of the invention, there is provided a screw holder for holding a screw to be driven by a screwdriver. The screw holder may include a longitudinal holder body with first and second ends. A through-hole may be provided from the first to the second end, with the first end having an opening configured to receive a blade and shank of a screwdriver, and the second end having an opening configured to receive the screw. The second end opening may progressively taper towards the first end. The through-hole may be configured to allow the blade of the screwdriver the engage with the head of the screw within the holder body.

The screw holder may also include an aligner connected to the second end opening to snugly hold the screw and substantially align the screw with the screwdriver during the screwdriving process.

The screw holder may also include an engager inside the second end opening for engaging the head of the screw to the blade of the screwdriver. The engager may include a roughened surface along the second end opening to engage the head of the screw.

The holder body may be configured to receive various sized screwdriver shanks. The holder body may have a slit in at least said first end to receive various sized screwdriver shanks.

The aligner may include a membrane extending across the second end opening and the membrane may include an opening to receive the screw. The membrane may be made of an elastomeric or polymeric material.

In accordance with another embodiment of the invention, there is provided a screw holder for holding a screw to be driven by a screwdriver. The screw holder may include a longitudinal holder body having first and second ends. The holder body may have a through-hole from the first to the second end, with the first end having an opening configured to receive a blade and shank of a screwdriver, and the second end having an opening configured to receive the screw. The second end opening may progressively taper towards the first end. The second end opening may have a roughened inner surface for engaging the head of the screw to the blade of the screwdriver.

The screw holder may also include a membrane extending across the second end opening and the membrane may have an opening to receive the screw. The membrane may be configured to snugly hold the screw and substantially align the screw with the screwdriver during the screwdriving process.

The through-hole may be configured to allow the blade of the screwdriver to engage with the head of the screw within the holder body.

The holder body may be configured to receive various sized screwdriver shanks. The holder body may have a slit in at least said first end to receive various sized screwdriver shanks.

The membrane may be made of an elastomeric or polymeric material.

### BRIEF DESCRIPTION OF THE DRAWINGS

These and other features will become more apparent from the following description in which reference is made to the appended drawings. The drawings are for the purpose of illustration only and are not intended to be in any way limiting.

FIG. 1 is a perspective view of the prior art showing the Wera™ Screw Grabber;

FIG. 2 is an illustration of the preferred embodiment showing the universal screw holder with a spiral slot surrounding the length of the screw holder;

FIG. 3 depicts the preferred embodiment without the screw inserted into the screw holder;

FIG. 4 is a sketch of an alternate embodiment showing a straight, linear slot along the length of the screw holder; and

FIG. 5 shows a further alternate embodiment, where there are, for illustration, two slits shown along the length of the screw holder.

### DETAILED DESCRIPTION

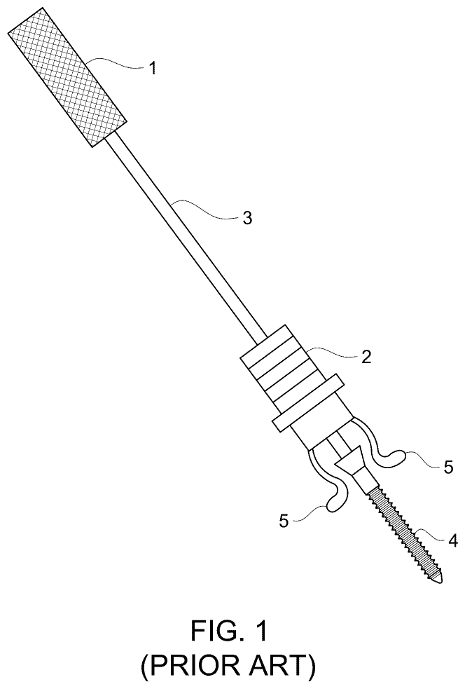

FIG. 1 shows a perspective view of the prior art 1 (the Wera™ Screw Grabber), specifically the screw grabber 2 attached to screwdriver 3, with screw grabber 2 holding screw 4 via clips 5 holding screw 4. The Wera™ Screw Grabber 2 is made by Bitburger™ (Germany) and is commercially available.

Limitations of the Wera™ Screw Grabber 2 design include high cost, namely over $10.00 USD per unit. Also, the Wera™ design is limited in that it is not adapted to accommodate larger diameter screwdrivers, as the inner diameter of the Screw Grabber is fixed and cannot expand.

Also, clips 5 on the Wera™ Screw Grabber 2 need to be flexible, and as such, are relatively fragile and, over time, would tend to work harden, and become prone to breaking from such work hardening process.

Additionally, since clips 5 are only attached at one location on screw 4, such design still allows screw 4 to twist to one side, and cause misalignment of the screw shaft and the screwdriver shaft, thereby preventing screw insertion using only one hand turning screwdriver 3.

Other screw grabber prior art includes devices such as commercially available Phillips #2 screwdriver, having an integrated screw holder configuration on the tip of the screwdriver, where such tip is adapted to hold the screw head, but only with one size screw head matching the size of screwdriver tip, greatly reducing the versatility of such a design.

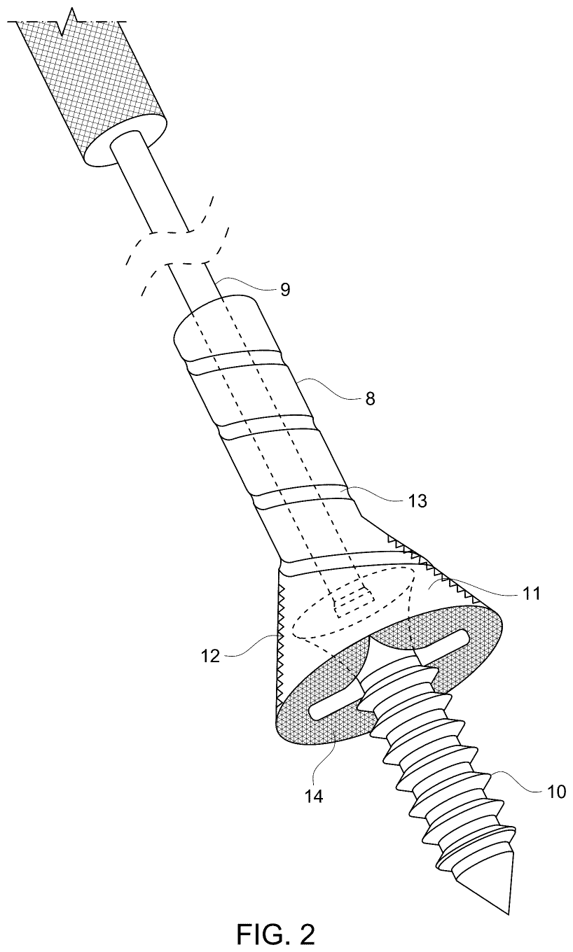

FIG. 2 illustrates the preferred embodiment screw holder 8, showing screw holder 8 held to screwdriver shaft 9, and screw 10 held by funnel shaped portion 11 of screw holder 8. Screw 10 is held at one end by friction induced by the features imprinted onto surface 12 of the inside surface of funnel 11, which surface features 12 can be, for example, notched, serrated, dimpled, concentric protruding rings and such.

A key feature of the non-smooth surface features of screw holder 8 is that screw 10 is held snugly, and in linear alignment with the longitudinal direction of screwdriver shaft 9. Additionally, since the funnel portion 11 of screw holder 8 is also encircled by spiral slit 13, such design allows for expansion of the inner diameter of cone 12, ensuring that screw 11 is snugly held on the inside of cone 11.

Additionally, and critically, the inventive screw holder 8 design is also adapted to hold a screw at a second location, namely by engaging a slitted elastomeric, or polymeric, covering 14 attached at the circumference of the larger diameter opening of funnel 11. Such second securing contact acts to hold screw 10 in longitudinal alignment with screwdriver shaft 9, thus inhibiting twisting and misalignment of screw 10.

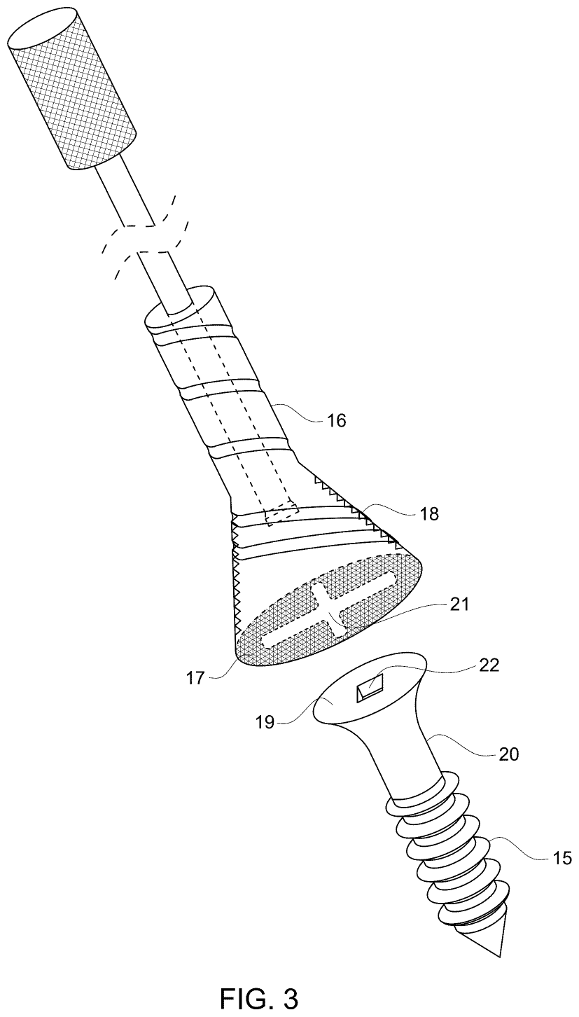

FIG. 3 depicts the preferred embodiment without screw 15 inserted into screw holder 16, where screw holder 16 is comprised of an elastomeric or polymeric membrane 17 covering funnel 17, which membrane 17 is anchored at the circumference of funnel 18, with four radial slits 21 in membrane 17 covering the opening of funnel 18. Such slitted design covering funnel 18 allows screw head 19 and screw body to push through the four slits in membrane 17, with the now slightly inward bending flaps, formed by the four slits 21, acting to hold the body screw 15 from twisting or bending out of alignment.

The top of screw 15, shown as 22, also engages the tip of screwdriver 16 when screw 15 is fully engaged in screw holder 16.

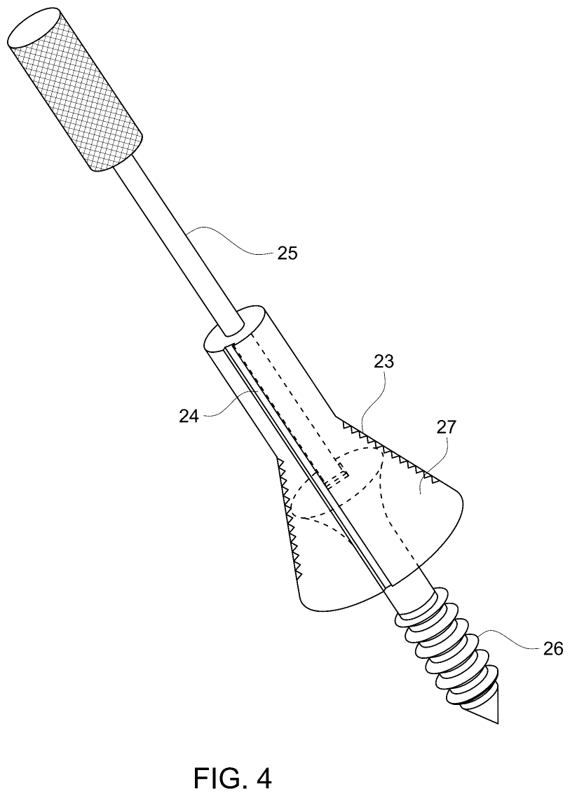

FIG. 4 depicts an alternate embodiment of the screw holder, shown as 23, but with a single linear spiral slit 24 along the length of screw holder 23. Such design, although feasible, does not allow for the even circular expansion of screw holder 23 inner diameter, thereby reducing the snug fit of both screwdriver shaft 25 and the holding of screw 26 by the features of the non-smooth inner funnel surface 27. This design can also be adapted to hold a slitted membrane covering the funnel opening as shown in FIG. 3.

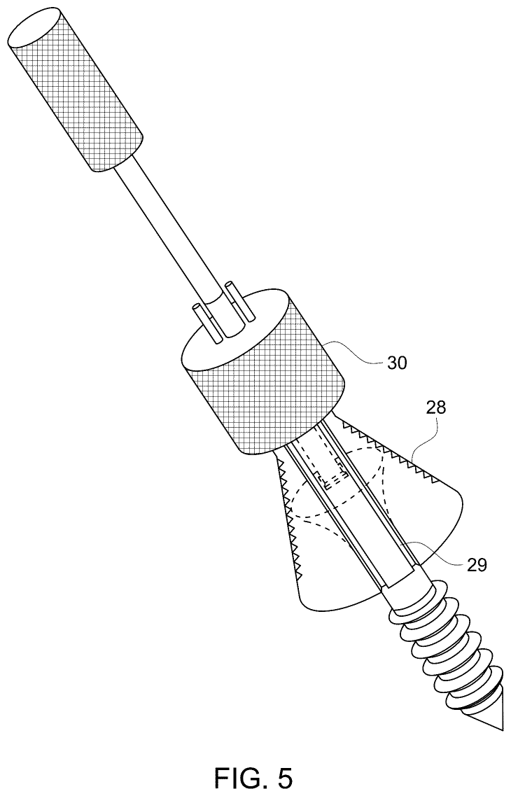

In a further alternate embodiment, shown in FIG. 5, screw holder 28 contains three or more linear slits 29 (only two linear slits are shown) along the entire length of screw holder 28, similar to the single slit design depicted in FIG. 4, but with at lest three slits rather than one slit. This design can be adapted to hold a slitted covering over the funnel opening as shown in FIG. 3.

Such design as shown in FIG. 5, also includes a rubber sleeve 30 around the length of screw holder 28, which rubber sleeve 30 can be the length of screw holder 28, or some portion thereof. Such rubber elastomeric sleeve 30 can also be adhesively fixed to screw holder 28. Or part or all of the entire length of screw holder 28 can be dip-coated in a liquid elastomeric material, thereby holding the slitted parts of screw holder 28 together, but still able to expand radially.

I claim:

1. A screw holder for holding a screw to be driven by a screwdriver, the screw holder comprising:
a longitudinal holder body comprising first and second ends, said holder body comprising a through-hole from said first to said second end, said first end comprising an opening configured to receive a blade and shank of a screwdriver, said second end comprising an opening configured to receive the screw, said through-hole configured to allow the blade of the screwdriver the engage with the head of the screw within said holder body; and
an aligner connected to said second end opening to snugly hold the screw and substantially align the screw with the screwdriver during the screwdriving process.

2. The screw holder of claim 1 wherein said second end opening progressively tapers towards the first end.

3. The screw holder of claim 1 further comprising an engager inside said second end opening for engaging the head of the screw to the blade of the screwdriver.

4. The screw holder of claim 3 wherein said engager comprises a roughened surface along said second end opening to engage the head of the screw.

5. The screw holder of claim 1 wherein said holder body is configured to receive various sized screwdriver shanks.

6. The screw holder of claim 5 wherein said configured holder body comprises a slit in at least said first end.

7. The screw holder of claim 1 wherein said aligner comprises a membrane extending across said second end opening, said membrane comprising an opening to receive the screw.

8. The screw holder of claim 7 wherein said membrane is comprised of an elastomeric or polymeric material.

9. A screw holder for holding a screw to be driven by a screwdriver, the screw holder comprising:
a longitudinal holder body comprising first and second ends, said holder body comprising a through-hole from said first to said second end, said first end comprising an opening configured to receive a blade and shank of a screwdriver, said second end comprising an opening configured to receive the screw, said second end opening progressively tapering towards said first end, said second end opening comprises a roughened inner surface for engaging the head of the screw to the blade of the screwdriver;
a membrane extending across said second end opening, said membrane comprising an opening to receive the screw, said membrane configured to snugly hold the screw and substantially align the screw with the screwdriver during the screwdriving process; and
wherein said through-hole is configured to allow the blade of the screwdriver to engage with the head of the screw within said holder body.

10. The screw holder of claim 9 wherein said holder body is configured to receive various sized screwdriver shanks.

11. The screw holder of claim 10 wherein said configured holder body comprises a slit in at least said first end.

12. The screw holder of claim 9 wherein said membrane is comprised of an elastomeric or polymeric material.
